(19) United States
(12) Patent Application Publication
(10) Pub. No.: US 2015/0032301 A1
(43) Pub. Date: Jan. 29, 2015

(54) TWO TIERED ENERGY STORAGE FOR A MOBILE VEHICLE

(71) Applicant: Electro-Motive Diesel, Inc., Lagrange, IL (US)

(72) Inventor: HARINDER Singh LAMBA, Downers Grove, IL (US)

(73) Assignee: Electro-Motive Diesel, Inc., Lagrange, IL (US)

(21) Appl. No.: 13/952,735

(22) Filed: Jul. 29, 2013

(51) Int. Cl. B60L 11/18; B61C 7/04

(52) U.S. Cl. CPC B60L 11/1809; B61C 7/04; Y10S 903/903
USPC 701/19; 701/22; 903/903

(57) ABSTRACT

A method of storing energy produced by a mobile vehicle is disclosed. The method may include receiving information on a vehicle trip profile. An electrical mode of a traction motor configured for propelling the vehicle may be changed from a motor mode where the traction motor receives electrical power to a generator mode where the traction motor produces electrical power when the trip profile indicates a charging opportunity. The method may further include directing energy generated by the traction motor in generator mode to a first tier of one or more energy storage devices with first rate-of-energy-absorption capabilities. A second tier of one or more energy storage devices with second rate-of-energy-absorption capabilities slower than the first rate-of-energy-absorption capabilities may then be charged with energy from the first tier energy storage devices. The charging of the second tier energy storage devices may continue when the traction motor is no longer producing electrical power.

### TECHNICAL FIELD

The present disclosure relates generally to energy storage and, more particularly, two tiered energy storage for a mobile vehicle.

### BACKGROUND

Modern vehicles such as locomotives and heavy trucks are increasingly being equipped with regenerative power sources, energy storage devices, and power-consuming equipment. Regenerative power sources such as traction motors in a dynamic braking mode have the potential to increase fuel economy and/or other performance characteristics of these vehicles. One problem associated with regenerative power sources is that the amount and rate of power produced may exceed the power charging capacity of known battery systems. Conventional energy management controllers therefore often waste much of the energy produced by dissipating the energy as heat in a resistance grid.

One attempt to improve the efficiency of a hybrid vehicle is disclosed in U.S. Pat. No. 4,199,037 of White that issued on Apr. 22, 1980 (the '037 patent). The '037 patent provides an electrically-driven vehicle with a turbine engine, a generator driven by the turbine engine, a battery for storing electrical energy, and traction motors for driving wheels of the vehicle. The traction motors are powered by electrical energy that can be obtained directly from the generator or from the battery. A controller turns the turbine engine on whenever the amount of usable energy stored in the battery drops below a first predetermined level. The '037 patent also discloses maintaining the speed of the turbine at a constant level to maximize its efficiency.

Although the hybrid system of the '037 patent may improve the efficiency of the disclosed vehicle, it may be less than optimal. In particular, the disclosed hybrid system of the '037 patent does not provide any means for storing energy other than a battery. When the stored energy in the battery rises above a predetermined level, the turbine engine is shut off and the only source of energy becomes the battery until the turbine engine is turned back on to drive a DC generator and recharge the battery. As a result, the system of the '037 patent may not allow for operation of the turbine engine at its point of maximum efficiency, and may not be able to store all of the excess energy produced by the turbine and/or traction motors as rapidly as desired in some situations.

The system and method of the present disclosure solves one or more problems set forth above and/or other problems in the art.

### SUMMARY

In one aspect, the present disclosure is directed to a method of storing energy produced by a mobile vehicle. The method may include receiving information on a vehicle trip profile, and changing an electrical mode of a traction motor configured for propelling the vehicle. The mode may be changed from a motor mode, where the traction motor receives electrical power, to a generator mode, where the traction motor produces electrical power when the trip profile indicates a charging opportunity. The method may further include directing energy generated by the traction motor in the generator mode to a first tier of one or more energy storage devices with first rate-of-energy-absorption capabilities. A second tier of one or more energy storage devices may be provided with second rate-of-energy-absorption capabilities slower than the first rate-of-energy-absorption capabilities. The second tier of one or more energy storage devices may be charged with energy from the first tier of one or more energy storage devices.

In another aspect, the present disclosure is directed to an energy management system on a mobile vehicle. The energy management system may include a first tier energy storage device having a first rate-of-energy-absorption capability, and a second tier energy storage device having a second rate-of-energy-absorption capability slower than the first rate-of-energy-absorption capability. A controller may also be provided and configured for receiving information on a vehicle trip profile and changing an electrical mode of a traction motor configured for propelling the vehicle from a motor mode where the traction motor receives electrical power to a generator mode where the traction motor produces electrical power when the trip profile indicates a charging opportunity. The controller may be configured for directing energy generated by the traction motor in generator mode to the first tier energy storage device. The controller may be further configured for initiating charging of the second tier energy storage device with energy from the first tier energy storage device.

### BRIEF DESCRIPTION OF THE DRAWINGS

FIG. 1 is a schematic illustration of a mobile vehicle with an exemplary disclosed energy management controller;

FIG. 2 is a flowchart depicting an exemplary energy management method that may be performed by the energy management controller of FIG. 1.

### DETAILED DESCRIPTION

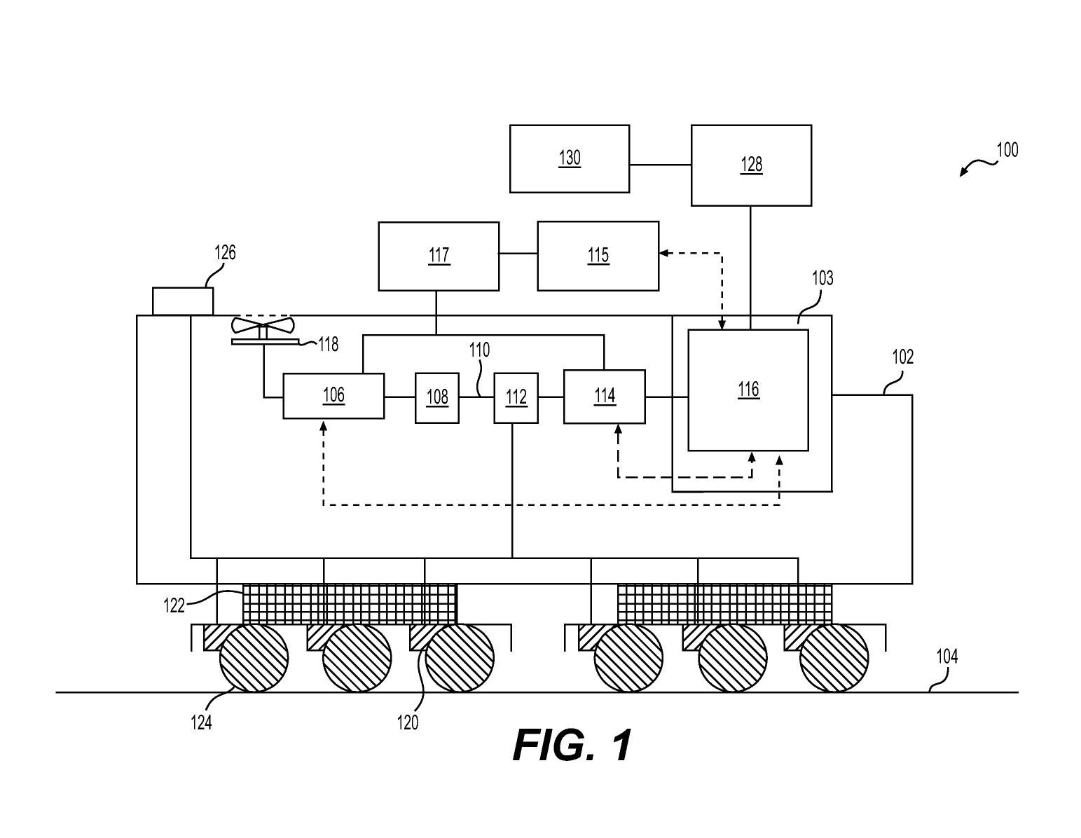

FIG. 1 is a schematic illustration of a mobile vehicle system including an energy management system according to this disclosure. In the exemplary embodiment of FIG. 1, the mobile vehicle system is depicted as a locomotive 100 configured to run on track 104. The locomotive may be a diesel-electric vehicle operating a diesel engine 106 located within a main engine housing 102. However, in alternative implementations of locomotive 100, alternate engine configurations may be employed, such as a gasoline internal combustion engine, a gas turbine engine, a biodiesel engine, and a natural gas engine, for example. It is contemplated that the vehicle may alternatively be an on-road truck, bus, van, passenger vehicle, off-highway vehicle (OHV) such as a large excavator, excavation dump truck, and the like.

The energy management system of locomotive 100 may include an energy management controller 116, first tier energy storage devices such as ultra-capacitors and inertial energy storage devices contained within energy storage banks 115, and second tier energy storage devices such as batteries 114. Locomotive operating crew and electronic components involved in locomotive systems control and management, such as energy management controller 116, may be housed within a locomotive cab 103. Energy management controller 116 may include a plurality of controllers, which may include microprocessors and/or computers. Energy management controller 116 may communicate with a vehicle control system 128. Vehicle control system 128 may be an on-board control system also located in locomotive cab 103. Alternatively, vehicle control system 128 may be remotely located.

Vehicle control system 128 and/or energy management controller 116 may further include a position identification system. The position identification system, such as a global positioning system (GPS), inertia based location system, wayside based location system and the like, may be configured for enabling energy management controller 116 to base energy management decisions at least partially on upcoming trip profiles. As one example, energy management controller 116 may be configured to determine from the present location of a train relative to upcoming terrain that future charging opportunities may be available. Charging opportunities refers to situations where traction motors 120 used to propel the train may be operated in a regenerative, dynamic braking mode where they produce electrical energy rather than consume electrical energy.

A determination that a long, downhill slope lies ahead of the train may cause energy management controller 116 to direct increased usage of stored energy in order to free up additional energy storage capacity in energy storage banks 115. When the train begins down the slope, energy management controller 116 may be configured to initiate a dynamic braking mode upon receiving a braking signal. In alternative implementations, the dynamic braking mode may be initiated in anticipation of a future braking signal, or in some situations only after having already received a braking signal. A braking signal may be generated by an operator on the train, a remote central control station, or a wayside station along the train track. DC contactors or switches at one or more positions along an electrical power bus 110 on the train may disconnect a portion of the system feeding power from diesel engine 106 and alternator 108 to traction motors 120 that drive the train. Energy management controller 116 may be configured to switch the operating mode of traction motors 120 from a motor mode, during which the traction motors receive electrical power from power bus 110, to a generator mode, during which the traction motors generate electrical power and provide that power back to power bus 110. Traction motors 120 in a generator mode perform dynamic braking, as discussed in more detail below. Dynamic braking may provide a smoother deceleration for the train on the downhill slope than would be provided by mechanical or pneumatic braking using disk or drum brakes.

Diesel engine 106 generates a torque that is transmitted to alternator 108 along a drive shaft (not shown). The generated torque is used by alternator 108 to generate electricity for subsequent propagation along electrical power bus 110 of locomotive 100. Engine 106 may be run at a constant speed, or at variable speed, generating horsepower output based on operational demand. The electrical power generated in this manner may be referred to as the prime mover power. Auxiliary diesel engines-alternators or other alternate energy sources 117 generating smaller amounts of power (auxiliary power) for auxiliary components such as air conditioning, heating, and air compressors may also be provided. The electrical power may be transmitted along electrical power bus 110 to a variety of downstream electrical components. Based on the nature of the generated electrical output, the electrical power bus may be a direct current (DC) bus or an alternating current (AC) bus.

Alternator 108 may be connected in series to one or more rectifiers that convert the alternator's electrical output to DC electrical power prior to transmission along power bus 110. Based on the configuration of a downstream electrical component receiving power from power bus 110, an inverter 112 may be used to convert the DC electrical power to AC electrical power. In one embodiment of locomotive 100, a single inverter 112 may supply AC electrical power from power bus 110 to a plurality of components. In alternative implementations, each of a plurality of distinct inverters may supply electrical power to a distinct component. It will be appreciated that in still further implementations, the locomotive may include one or more inverters connected to a switch that may be controlled to selectively provide electrical power to different components connected to the switch.

As shown in FIG. 1, traction motor 120, mounted on a truck 122 below the main engine housing 102, may receive electrical power from alternator 108 via power bus 110 to provide tractive power to propel the locomotive. Traction motor 120 may be an AC motor. Accordingly, an inverter paired with the traction motor may convert DC input from power bus 110 to an appropriate AC input, such as a three-phase AC input, for subsequent use by the traction motor. In alternate implementations, one or more traction motors 120 may be DC motors directly employing the output of alternator 108 after rectification and transmission along power bus 110. In one exemplary implementation, a locomotive configuration may include one inverter-traction motor pair per wheel axle 124. As depicted in FIG. 1, six inverter-traction motor pairs may be provided for each of six axle-wheel pairs of locomotive 100. In alternate implementations, locomotive 100 may be configured with four inverter-traction motor pairs, for example. It will be appreciated that alternatively a single inverter 112 may be paired with a plurality of traction motors 120.

As discussed above, each traction motor 120 may also be configured to act as a generator providing dynamic braking to slow down locomotive 100. In particular, during dynamic braking, each traction motor 120 may provide torque in a direction that is opposite from the torque required to propel the vehicle in the rolling direction. This resistive torque may be a function of the quantity of electricity that is regenerated by each traction motor in generator mode. The rate at which electricity is regenerated by the traction motors during dynamic braking may be in excess of a preferred rate-of-charge of energy storage devices such as batteries, or may even be a rate-of-charge that would damage the batteries. As one non-limiting example, in a case where six traction motors on a locomotive are generating a total of approximately 3000 kilowatts of electrical power during dynamic braking, this amount of electrical power may be produced over a relatively short period of time, such as one-tenth of an hour. The electrical energy produced by the traction motors in one-tenth of an hour would be 300 kilowatt-hours (kWh). In order to absorb all of this energy a battery would require a rate-of-energy-absorption of at least 300 kWh. This rate-of-energy-absorption may be in excess of the capacity of the one or more batteries that may be provided in a second tier of energy storage devices. Accordingly, in order to avoid damaging the batteries, at least a portion of the generated electrical power may be routed to a grid of resistors 126 and dissipated as heat. In one example, the grid includes stacks of resistive elements connected in series directly to the electrical bus. The stacks of resistive elements may be positioned proximate to the ceiling of main engine housing 102 in order to facilitate air cooling with the assistance of a fan 118 and heat dissipation from the grid. In addition, during periods when the engine 106 is operated such that it provides more power than is needed to drive the traction motors 120, the excess capacity (also referred to as excess prime mover power) may be optionally stored in a combination of energy storage devices. The dissipation of excess energy through the resistive elements may result in the waste of a significant portion of the energy being produced during dynamic braking with the traction motors.

In accordance with various implementations of energy management controller 116 as set forth in this disclosure, the wasting of energy through heat dissipation, or potential damage to second tier energy storage devices such as batteries 114 may be avoided. Energy management controller 116 may be configured for receiving information on a vehicle trip profile and generating a signal indicative of a command to change the electrical mode of a traction motor configured for propelling the vehicle from a motor mode to a generator mode. A command to change the electrical mode of a traction motor to a generator mode may be received from one or more of an on-board operator, a central command center, a dispatch center, a wayside station, or the like. This command may coincide with a braking command, or may be received before or after an actual braking command has been received. Energy management controller 116 may be configured to anticipate a need to slow the train based on upcoming changes in terrain, an approaching crossing or switch yard, or other operational, geographical, or weather-related characteristics.

Energy management controller 116 may be configured for directing all energy generated by the traction motor in the generator mode to a first tier of one or more energy storage devices. The first tier energy storage devices may include one or more of super-capacitors, ultra-capacitors, and inertial energy storage devices such as flywheel systems. The first tier energy storage devices may have relatively faster charging capabilities as compared to a second tier of one or more energy storage devices, such as batteries. Charging capabilities of an energy storage device may also be referred to as the “rate-of-energy-absorption” capabilities of the energy storage device. Energy management controller 116 may be further configured for initiating the slow charging of the second tier energy storage devices with energy from the first tier energy storage devices while still directing energy generated by the traction motor to the first tier energy storage devices. Continued charging of the second tier energy storage devices with energy from the first tier energy storage devices may continue after the traction motor is no longer in the generator mode. As explained further below, “slow charging” of the second tier energy storage devices may refer to any rate of charging that is slower than the rate at which electrical energy is produced by the traction motors in a dynamic braking mode. Energy management controller 116 may be configured to determine the rate at which to charge the second tier energy storage devices based at least in part on a rate of charge that will increase the life of the second tier energy storage devices and enable capture of an increased amount of energy. Energy storage banks 115 may include the first tier energy storage devices. The second tier energy storage devices may be one or more batteries 114 or banks of batteries connected to receive electrical power from power bus 110.

A characteristic of the first tier energy storage devices may be their ability to rapidly absorb energy being produced at a fast rate, such as the electrical energy being produced by traction motors in dynamic braking mode. Another characteristic of the first tier energy storage devices may be that they are not able to store the energy for as long a period of time as the second tier energy storage devices. As an example, ultra-capacitors may be configured to rapidly absorb all of the energy being produced at a high rate of speed by traction motors 120. In the example discussed above, a high rate of speed may be the ability to absorb electrical energy being produced at the rate of approximately 300 kWh. One of ordinary skill in the art will recognize that the “high” rate-of-energy-absorption that may be necessary to capture all or the majority of the energy being produced by traction motors in dynamic braking mode may vary, depending on the number of traction motors and their rated capacity. However, the ultra-capacitors may not be configured to store the energy for long periods of time without some leakage. Similarly, inertial energy storage devices may be capable of being rapidly driven up to high rates of rotation by associated motors that receive electrical power from the traction motors in dynamic braking mode. Very low friction bearings may allow the inertial energy storage devices to store the energy as mechanical inertia for relatively long periods of time. However, mechanical friction may ultimately result in the loss of some of the stored energy at a more rapid rate than would be the case with the batteries of the second tier energy storage devices.

As discussed above, second tier energy storage devices, such as one or more batteries 114, may be linked to power bus 110. A converter (not shown) may be configured between power bus 110 and one or more batteries 114, to allow high voltage that may be supplied to power bus by alternator 108 to be stepped down appropriately for use by the battery. With the presence of such a converter, second tier energy storage devices such as batteries 114 may be charged to some extent with the power in power bus 110 produced by running engine 106. Alternatively, batteries 114 may be partially or completely charged by electrical energy received from the first tier energy storage devices. By first supplying electrical power produced at high rates of speed by traction motors 120 in dynamic braking mode to the first tier energy storage devices, energy management controller 116 may be configured to facilitate the capture of all, or nearly all, of the energy produced. This feature may avoid wasting the regenerated energy that cannot be captured by batteries. Energy management controller 116 may be further configured to slowly charge batteries 114 in the second tier of energy storage devices at a controlled rate with power from the first tier energy storage devices. The slow charging of the batteries may be calibrated to increase the amount of energy that can be stored by the batteries. The two-tiered system may enable energy management controller 116 to avoid over-charging the batteries and causing potential damage or reducing the life of the batteries.

The electrical energy stored in the second tier energy storage devices may be used during a stand-by mode of engine operation to operate various electronic components such as lights, on-board monitoring systems, microprocessors, processor displays, climate controls, and the like. In hybrid locomotives, or other hybrid electric propulsion systems, the electrical energy stored in one or more batteries or alternate energy storage devices, may also be used to propel the vehicle. In various implementations, the stored energy from one or both of the first tier and second tier energy storage devices may be converted as necessary and supplied to power bus 110 for various uses. This stored power may be used to provide energy to crank and start-up engine 106 from a shutdown condition. The stored power may also enable configuration of a locomotive with a smaller prime mover power source, such as diesel engine 106. In various configurations, energy management controller 116 may enable the use of a diesel engine or other power source that can be sized to operate within its most efficient operating zone for the majority of a trip profile. Energy stored in the first and second tier energy storage devices may be available to make up for any deficiencies encountered during high energy consumption periods, such as long uphill grades.

Energy storage banks 115 of a first tier of energy storage devices may include, for example, super-capacitors or ultra-capacitors, flywheel systems, or a combination thereof. The storage banks may be used separately or in any combination with the second tier energy storage devices such as batteries 114. When in combination, the different tiers of energy storage devices may provide synergistic benefits not realized with the use of any single energy storage device. For example, an inertial energy storage system such as a flywheel system may be able to store electrical energy relatively fast, but may be relatively limited in its total energy storage capacity. Similarly, an ultra-capacitor system may be able to store electrical energy relatively fast, but may be relatively limited in its total energy storage capacity. On the other hand, a battery system may store electrical energy relatively slowly, but may be configured with a large total energy storage capacity. Thus, when combined, the first and second tier energy storage devices may capture dynamic braking energy that cannot be timely captured by batteries alone. Energy management controller 116 may be configured to extend energy storage capabilities for the train or other mobile vehicle beyond the limits of systems that only employ a single type of energy storage device.

A plurality of energy storage banks 115 and batteries 114 may be located on the same locomotive or on one or more alternate locomotives. Further still, alternate energy sources 117, such as one or more diesel engines and associated alternators, may be used to transfer energy to the on-board energy storage devices, such as battery 114. The alternate energy sources 117 and/or the energy storage banks 115 may also be managed by energy management controller 116.

Energy management controller 116 may be configured to adjust a charging/discharging rate and/or a power transfer rate to and/or from battery 114. These rates may be based at least partially on data pertaining to the operating condition of battery 114. The data may include a battery state of charge (SOC), a battery temperature and/or temperature gradient, and a frequency of usage. Other factors relevant to battery operating condition may include a number of charging/discharging cycles that have elapsed, a power transfer current and voltage, a total number of kilowatt-hours in a charge mode, a total number of kilowatt-hours in a discharge mode, and total operating hours in charge/discharge mode. Additional factors may include a number of vehicle missions completed, vehicle distance traveled, elapsed time in operation, and the like. Further, an associated position identification system, such as a GPS, or an associated vehicle control system 128 may provide the energy management controller with details of current and future trip profiles 130, including but not limited to grades, speed limits, curvature, and altitude. Energy management controller 116 may also be configured to receive data pertaining to vehicle driving characteristics such as a vehicle speed, power, and braking occurrences. An upper and a lower threshold for the charging/discharging rate and/or the desired state of charge of battery 114 may accordingly be adjusted responsive to a temperature, age, frequency of usage, efficiency, and other operating parameters of the battery. Factors related to any particular trip profile may also be taken into consideration. As the trip profile and/or battery operating parameters change, the charging/discharging profile may be revised and updated. Energy management controller 116 may therefore be configured to increase energy storage and the life and health of the energy storage devices. As one non-limiting example, the rate at which energy is transferred from first tier energy storage devices such as an ultra-capacitor and a flywheel to a second tier energy storage device such as a battery may be decreased as the battery increases in age and frequency of use.

In alternative implementations where engine 106 may be a turbine engine, the rotating components of the turbine engine and alternator 108, such as rotating turbine blades, and the alternator rotor, may reach speeds of 40,000 to 60,000 revolutions per minute (RPM) or higher. These rotating components may therefore store significant amounts of energy as rotational inertia. The rotational inertia of these rotating components may provide another first tier energy storage device in addition to the devices of energy storage banks 115. The rotating components of a turbine-alternator may spin freely as one rotational unit when fueled. This high speed rotation may continue after the fuel supply is cut off for a significant period of time as a result of the high inertia of the rotating components, and the relatively low friction losses experienced by the rotating components. The inertial energy stored in the high speed rotating components of a turbine and alternator combination would be available without having to first convert electrical energy produced by traction motors 120 into the torque that drives flywheels of energy storage banks 115. In either case though, inertial energy storage may allow for rapid storage of excess energy, such as may be obtained during regenerative or dynamic braking or when energy in excess of a power demand is produced by engine 106. The inertial energy storage may also allow for a more rapid or instant access to energy than may be possible with second tier energy storage devices such as battery 114. Second tier energy storage devices such as battery 114, on the other hand, may allow for a larger capacity for longer term, steady-state energy storage than may be possible with ultra-capacitors or inertial energy storage.

As shown in FIG. 1, engine 106 and alternator 108 may provide three phase alternating current (AC) to an AC-to-DC converter or rectifier, and the resulting direct current (DC) may be provided over power bus 110 to a DC-to-AC inverter 112, which may output three-phase electric power having three alternating currents to one or more traction motors 120. Some of the DC electrical power in power bus 110 may also be passed through a converter if necessary and provided to second tier energy storage devices such as battery 114. Energy management controller 116 may be configured to direct a portion of the DC from power bus 110 into one or more batteries 114 of the second tier energy storage devices when the power required by the one or more traction motors 120 is less than the total power being generated by engine 106 and alternator 108. When electrical power is received from one or more traction motors 120, energy management controller 116 may be configured to determine that the rate of energy being received is too great for a rate-of-energy-absorption capability of battery 114. The rate at which energy is received from alternator 108 may also exceed the rate-of-energy-absorption capability of battery 114. Such a determination may change based on at least the factors discussed above, such as current operating parameters of battery 114. In various implementations of this disclosure, energy management controller 116 may therefore automatically direct some or all energy produced by traction motors 120 during dynamic braking to first tier energy storage devices in energy storage banks 115. Similarly, if the rate at which energy is being supplied to power bus 110 by the engine-alternator combination exceeds the capacity of battery 114, energy management controller 116 may direct some or all of that energy to first tier energy storage devices in energy storage banks 115.

Energy management controller 116 may also be configured to provide anticipatory controls that take into consideration expected or known upcoming loads on the system based on acquired information such as the position of the system, maps of the conditions under which the system is being operated, or calculations or algorithms that determine anticipated loads from various inputs provided by sensors. Energy management controller 116 may be configured to include one or more processors, databases, look-up tables, maps, and other sources of information relevant to energy management processes performed by energy management controller 116. Energy management controller 116 may also be communicatively coupled over wired or wireless links (not shown) to other sources of network or non-network data, such as may be obtained from central control centers, wayside stations, dispatch centers, or from onboard sources such as a global positioning satellite receiver (GPS) or operator input. In various implementations energy management controller 116 may be configured to determine present and anticipated vehicle position information via a position identification system such as a GPS. This position information may be used to locate data in a database regarding present and/or anticipated terrain or track topographic and profile conditions that may be experienced by the train or other mobile vehicle. Such information may include, for example, track or terrain grade, elevation (e.g., height above mean sea level), train track curve data, train tunnel information, and speed limit information. This database information could be provided by a variety of sources including: an onboard database associated with energy management controller 116, a communication system such as a wireless communication system providing the information from a central source, manual operator input(s), one or more wayside signaling devices, or a combination of such sources. Other vehicle information such as the size and weight of the vehicle, a power capacity associated with the engine, efficiency ratings, present and anticipated speed, and present and anticipated electrical load may also be included in a database (or supplied in real or near real time) and used by energy management controller 116. In various alternative implementations, energy management controller 116 may be configured to determine energy storage and energy transfer requirements associated with the energy storage in a static fashion. For example, the system may be preprogrammed with any of the above information, or could use look-up tables or maps based on past operating experience.

Energy management controller 116 may use present and/or upcoming power demand information, along with vehicle status information, to determine power storage and power transfer requirements. Energy storage opportunities may be based on present and future likely power demand information. For example, based on terrain information, such as upcoming track characteristics information for a train, energy management controller 116 may be configured to determine whether it is more efficient to leave the engine in a fuel cut-off mode and use up energy stored in first tier energy storage devices such as flywheel systems and/or electrical energy stored in second tier energy storage devices such as batteries. Energy management controller 116 may be configured to make this determination even though present energy demand is low because a dynamic braking region is coming up. In this manner, energy management controller 116 may be configured to improve efficiency by accounting for the stored energy before a potential upcoming charging region is encountered. The fuel supply to the engine may remain turned off until both the inertial energy storage and the electrical energy storage have dropped below set thresholds. In the case of inertial energy storage, the set threshold may be a designated level or range of revolutions per minute (RPM), such as when a turbine engine that normally runs in the range from 40,000 RPM to 60,000 RPM has dropped below 48,000 RPM to 45,000 RPM. When the inertial energy storage is performed with one or more flywheel systems, a set threshold may be based upon the RPM of at least one of the flywheels. Similarly, the set threshold for an electrical energy storage device such as battery 114 may be a lower charge level or range of charge levels below which the battery should be recharged.

In operation, energy management controller 116 may be configured to determine power storage requirements and power transfer requirements. Energy management controller 116 may be configured to receive signals from sensors such as acceleration sensors, throttle position sensors, air intake sensors, brake sensors, and fuel-air ratio sensors. Data may also be received from various data sources including look-up tables and maps. Energy management controller 116 may be configured to determine whether power demands require shorter-term, faster access to energy or longer-term, more steady-state access to energy based on at least this acquired data. Exemplary applications for rapid storage and transfer of energy may include sudden braking and acceleration conditions on a vehicle. Longer term, more steady-state applications may include providing power to the traction components of a vehicle under constant velocity travel conditions or other steady-state conditions.

Energy management controller 116 may be further configured to establish priorities or rules regarding the storage and transfer of energy. In various implementations, the power transfer requirements may be determined at least partially as a function of a demand for power. In certain implementations, energy management controller 116 may be configured to provide a signal to fuel engine 106 only when both the first tier energy storage devices such as ultra-capacitors and flywheel systems have been depleted below a threshold level, and the second tier energy storage devices such as batteries have also been depleted below a threshold level. In other situations, depending on factors such as anticipated power demands, energy management controller 116 may be configured to run engine 106 at full power even though the energy storage devices have not been depleted. Energy management controller 116 may also be configured to anticipate upcoming power charging opportunities, such as when traction motors 120 may be run in dynamic braking mode. Based on this information, energy management controller 116 may be configured to draw down the energy stored in one or both of the first and second tier energy storage devices in order to free up more storage capacity. The two tiered energy storage system according to this disclosure may facilitate the capture of more of the energy regenerated by traction motors 120 during dynamic braking mode, with resultant increased overall fuel efficiency and reduced emissions.

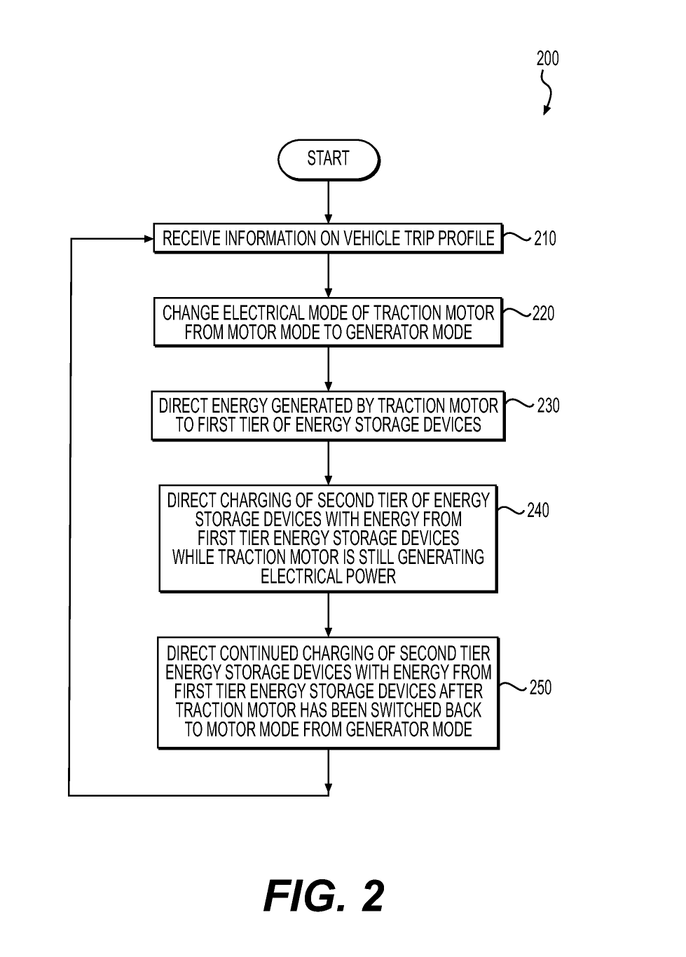

FIG. 2 illustrates steps of an exemplary disclosed energy storage and transfer method that may be performed by energy management controller 116. FIG. 2 will be discussed in the following section in order to further illustrate the disclosed concepts.

### INDUSTRIAL APPLICABILITY

The disclosed exemplary two tiered energy management system may provide improved fuel efficiency and reduced emissions. The system may also avoid wasting energy regenerated by traction motors in dynamic braking mode. Additional advantages of the two tiered energy management system may include increased battery life, and the ability to store energy available for shorter-term and faster demands for power, and longer-term, more steady-state demands for power. Significant fuel savings in particular may be achieved by controlling power transfer and storage of regenerated power produced by traction motors in dynamic braking mode. The energy management controller according to this disclosure may therefore allow for the use of a smaller prime mover power source than would normally be required for a particular trip profile. First tier energy storage devices may have high rate-of-energy-absorption capabilities that allow for the capture of all or nearly all of the electrical energy produced by the traction motors in dynamic braking mode. These first tier energy storage devices may also provide energy for power demands that may call for instant supply of energy. The second tier of energy storage devices may be charged with energy from the first tier energy storage devices at a rate suitable for a lower rate-of-energy-absorption capability that may not be sufficient to capture regenerated energy from the traction motors. Second tier energy storage devices such as batteries may also provide greater capacity for longer-term, more steady-state energy storage, and the availability of more stored energy over a longer period of time than may be available from the first tier energy storage devices.

As shown in flowchart 200 of FIG. 2, an energy management controller according to this disclosure may receive information on a vehicle trip profile at step 210. This information may come from sources that may include a position identification system, such as GPS, as well as operating information received in real time or taken from various databases.

Based at least in part on the vehicle trip profile information received at step 210, the energy management controller may change the electrical mode of one or more traction motors used to drive the vehicle from a motor mode to a generator mode at step 220. The energy management controller may provide anticipatory controls based on a position of the vehicle, maps, calculations of anticipated loads from sensory inputs, and an evaluation of the conditions under which the system is being operated. The energy management controller may also change the electrical mode of one or more traction motors to generator mode to initiate dynamic braking that may coincide with the receipt of a braking command. Alternatively, dynamic braking performed by the traction motors may be initiated before or after the receipt of a braking command.

At step 230, energy being generated by one or more traction motors operating in dynamic braking mode may be directed to a first tier of energy storage devices. These first tier energy storage devices may be selected with rate-of-energy-absorption capabilities that are sufficient to absorb all or nearly all of the electrical energy produced by the traction motors in dynamic braking mode.

At step 240, the energy management controller according to this disclosure may direct charging of second tier energy storage devices with energy from the first tier energy storage devices while the one or more traction motors are still generating electrical power. The rate at which the second tier energy storage devices are charged may be controlled to avoid damaging the second tier energy storage devices, and to increase the amount of power that may be stored. The transfer of energy from the first tier energy storage devices to the second tier energy storage devices also frees up more energy storage capacity in the first tier energy storage devices.

At step 250, the energy management controller may direct the continued charging of the second tier energy storage devices with energy from the first tier energy storage devices after the traction motors have been switched back to motor mode from generator mode. This may enable the transfer of the energy to storage devices with better long term storage capabilities before the first tier energy storage devices begin to lose any significant amount of the energy.

It will be apparent to those skilled in the art that various modifications and variations can be made to the disclosed two-tiered energy management system without departing from the scope of the disclosure. Other embodiments of the two-tiered energy management system will be apparent to those skilled in the art from consideration of the specification and practice of the methods disclosed herein. It is intended that the specification and examples be considered as exemplary only, with a true scope of the disclosure being indicated by the following claims and their equivalents.

What is claimed is:

1. A method of storing energy produced by a mobile vehicle, the method comprising:
receiving information on a vehicle trip profile;
changing an electrical mode of a traction motor configured for propelling the vehicle from a motor mode where the traction motor receives electrical power to a generator mode where the traction motor produces electrical power when the trip profile indicates a charging opportunity;
directing energy generated by the traction motor in the generator mode to a first tier of one or more energy storage devices with first rate-of-energy-absorption capabilities; and
charging a second tier of one or more energy storage devices with second rate-of-energy-absorption capabilities slower than the first rate-of-energy-absorption capabilities with energy from the first tier of one or more energy storage devices.

2. The method of claim 1, further including continuing the charging of the second tier of one or more energy storage devices when the traction motor is no longer producing electrical power.

3. The method of claim 1, wherein receiving information on a vehicle trip profile includes receiving information from one or more of operator input, central command input, a map or other database, a GPS, an inertia based location system, and a wayside based location system.

4. The method of claim 1, wherein the trip profile indicates a charging opportunity based at least in part on information indicative of one or more of operational, geographical, and weather-related characteristics.

5. The method of claim 1, wherein changing an electrical mode of a traction motor when the trip profile indicates a charging opportunity coincides with receiving a braking command.

6. The method of claim 1, wherein changing an electrical mode of a traction motor when the trip profile indicates a charging opportunity occurs before or after receiving a braking command.

7. The method of claim 1, wherein directing energy generated by the traction motor in generator mode to a first tier of one or more energy storage devices includes storing the energy in one or more ultra-capacitors.

8. The method of claim 1, wherein charging the second tier of one or more energy storage devices is performed at a controlled rate calibrated to increase the amount of energy stored in the one or more second tier energy storage devices.

9. The method of claim 1, wherein charging the second tier of one or more energy storage devices includes charging one or more batteries.

10. An energy management system on a mobile vehicle, the energy management system comprising:
a first tier energy storage device having a first rate-of-energy-absorption capability;
a second tier energy storage device having a second rate-of-energy-absorption capability slower than the first rate-of-energy-absorption capability; and
a controller configured for:
receiving information on a vehicle trip profile;
changing an electrical mode of a traction motor configured for propelling the vehicle from a motor mode where the traction motor receives electrical power to a generator mode where the traction motor produces electrical power when the trip profile indicates a charging opportunity;
directing energy generated by the traction motor in the generator mode to the first tier energy storage device; and
initiating charging of the second tier energy storage device with energy from the first tier energy storage device.

11. The energy management system of claim 10, wherein the controller is further configured for initiating charging of the second tier energy storage device with energy from the first tier energy storage device while still directing energy generated by the traction motor in the generator mode to the first tier energy storage device.

12. The energy management system of claim 11, wherein the controller is further configured for directing continued charging of the second tier energy storage device with energy from the first tier energy storage device after the traction motor is no longer in the generator mode.

13. The energy management system of claim 10, wherein the controller is configured for receiving information on a vehicle trip profile from one or more of operator input, central command input, a map or other database, a GPS, an inertia based location system, and a wayside based location system.

14. The energy management system of claim 10, wherein the controller is configured for changing an electrical mode of a traction motor when the trip profile indicates a charging opportunity based at least in part on one or more of operational, geographical, and weather-related characteristics.

15. The energy management system of claim 10, wherein the controller is configured for changing an electrical mode of a traction motor when the trip profile indicates a charging opportunity that coincides with receiving a braking command.

16. The energy management system of claim 10, wherein the controller is configured for changing an electrical mode of a traction motor when the trip profile indicates a charging opportunity that occurs before or after receiving a braking command.

17. The energy management system of claim 10, wherein the controller is configured for directing energy generated by the traction motor in generator mode to the first tier energy storage device by providing the energy to a motor that generates torque to rotate an inertial energy storage device.

18. The energy management system of claim 10, wherein the controller is configured for directing energy generated by the traction motor in generator mode to the first tier energy storage device by storing the energy in an ultra-capacitor.

19. The energy management system of claim 10, wherein the controller is configured for initiating charging of the second tier energy storage device at a controlled rate calibrated to increase the amount of energy stored in the second tier energy storage device.

20. A locomotive comprising:
a power bus;
an engine-alternator combination supplying power to the power bus;
a traction motor configured for propelling the locomotive when receiving power from the power bus in a motor mode and braking the locomotive when providing power to the power bus in a generator mode; and
an energy management system comprising:
a first tier energy storage device having a first rate-of-energy-absorption capability;
a second tier energy storage device having a second rate-of-energy-absorption capability slower than the first rate-of-energy-absorption capability; and
a controller configured for:
directing energy generated by one or both of the traction motor in generator mode and the engine-alternator combination to the first tier energy storage device; and
initiating charging of the second tier energy storage device with energy from the first tier energy storage device.
